(19) United States
(12) Patent Application Publication
(10) Pub. No.: US 2011/0257768 A1
(43) Pub. Date: Oct. 20, 2011

(54) CONTROL OF A DYNAMIC SYSTEM CROSS REFERENCE TO RELATED APPLICATION

(75) Inventors: Angeliki Pantazi, Zurich (CH); Abu Sebastian, Zurich (CH); Tomas Tuma, Zurich (CH)

(73) Assignee: INTERNATIONAL BUSINESS MACHINES CORPORATION, Armonk, NY (US)

(21) Appl. No.: 13/070,571

(22) Filed: Mar. 24, 2011

(30) Foreign Application Priority Data
Mar. 26, 2010 (EP) 10158018.1

(51) Int. Cl. G05B 13/02

(52) U.S. Cl. 700/33

(57) ABSTRACT

A control method for tracking a provided reference signal in a dynamical system. The control method includes a control function for controlling a controlled element of the dynamical system, wherein the control function outputs a control signal depending on the reference signal indicating a desired setting of the controlled element and a feedback signal indicating an actual state of the controlled element. An internal state of the control function is modified at one or more discrete time instants while applying the control function at time periods not including the discrete time instants. The modification of the internal state depends on a signal external to the control function.

### CROSS REFERENCE TO RELATED APPLICATION

This invention claims priority under 35 U.S.C. 119 from Swiss. Application 10158018.1, filed Mar. 26, 2010, the entire contents of which are incorporated herein by reference.

### BACKGROUND OF THE INVENTION

1. Field of the Invention

The present invention relates to the field of controls, in particular feedback controls used for the tracking of high-frequency input signals by means of a dynamical system, such as a positioning system.

2. Description of Related Art

In the field of nanotechnology, nanopositioning plays an important role in navigating on a nanometer scale. Most of the control work in nanopositioning relies on linear feedback control. For instance, there are inherent limitations on the performance of a linear feedback control system. Bode's integral theorem implies that a good tracking performance and noise robustness are conflicting goals. Due to the random nature, a positioning error, e.g. caused by measurement noise, is particularly detrimental to nanoscale applications.

As commonly known, the limitations of linear feedback control can be overcome by employing non-linear control schemes. Non-linear control schemes known in the art are disclosed, e.g. in documents J. C. Clegg, “A non-linear integrator for servomechanisms”, Transactions AIEE, Part II, Applications and Industry, Vol. 77, pages 41-42, 1958 and I. Horowitz and P. Rosenbaum, “Non-linear design for cost of feedback reduction in systems with large parameter uncertainty”, International Journal of Control, Vol. 21, pages 977-1001, 1975, and describe a reset control for resetting an integrator of the feedback controller for the feedback control at time instants when its input reaches zero.

The document A. Sebastian, S. O. R. Moheimani, “Signal transformation approach to fast nanopositioning”, Review of Scientific Instruments Vol. 80, 076101, 2009 discloses a method for high-precision tracking of repetitive jitter-free reference signals without being constrained by the reduction in measurement noise-induced positioning resolution. The method implies the transformation and inverse transformation between the repetitive reference signal and a dummy reference signal, wherein the controller is chosen such that the closed-loop system tracks the dummy reference signal with zero steady-state error. It is one idea therein that the problem of tracking a triangular signal is translated to that of tracking a ramp signal having a low frequency content instead of a high frequency content.

The solutions provided in the prior art show good results in terms of tracking performance, however, there is still a need to further improve the tracking performance of nanopositioning systems without increasing the bandwidth of the controller.

### BRIEF SUMMARY OF THE INVENTION

To overcome these deficiencies, the present invention provides a control method for tracking a provided reference signal in a dynamical system, including: controlling a controlled element of the dynamical system by means of a control function; outputting, by the control function, a control signal depending on a reference signal indicating a desired setting of the controlled element and a feedback signal indicating an actual state of the controlled element; and modifying an internal state of the control function at one or more discrete time instants while applying the control function at time periods not including the discrete time instants, wherein the modification of the internal state depends on a signal external to the control function.

According to another aspect of the present invention, the present invention provides a dynamical system for tracking a reference signal, including: a controlled element for being set according to a provided control signal; a controller for feedback controlling the controlled element by providing the control signal, wherein the controller is adapted to feedback control the controlled element depending on a provided reference signal and a feedback signal indicating an actual state of the controlled element; and an impulsive state modification block for modifying an internal state of the controller at one or more discrete time instants, while applying the control function at time periods not including the discrete time instants, wherein the impulsive state modification block is adapted to modify the internal state depending on a signal external to the controller.

### BRIEF DESCRIPTION OF THE SEVERAL VIEWS OF THE DRAWINGS

Preferred embodiments are described in detail in conjunction with the accompanying drawings in which:

FIG. 1 shows a block diagram of a feedback control loop with impulsive state modification for tracking of high-bandwidth piecewise constant signals according to a first embodiment;

FIG. 2 shows a block diagram of a control loop with impulsive state modification for tracking of high-bandwidth piecewise affine signals according to a second embodiment;

FIG. 3 shows diagrams illustrating the transfer function of an example nanopositioner;

FIGS. 4a to 4c show time diagrams illustrating the tracking error and an integrator state with an open loop control, with a feedback control without impulsive control, and with a feedback control with impulsive control;

FIG. 5 shows a comparison of the tracking error with and without the impulsive feedforward for different controller gains according to a simulation run;

FIG. 6 shows a block diagram for a feedback control system, wherein the internal state of the controller is made dependent on an output measurement, i.e. a feedback signal; and

FIG. 7 shows a block diagram for a feedback control system, wherein the internal state of the controller is made dependent on a differential input of the controller.

### DETAILED DESCRIPTION OF THE PREFERRED EMBODIMENTS

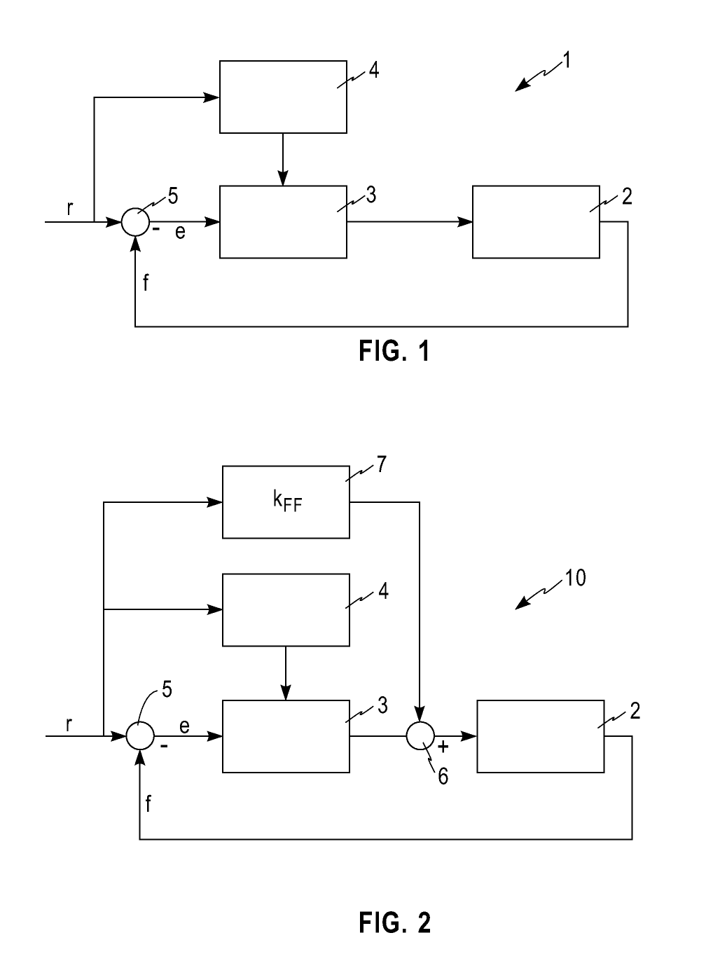

FIG. 1 shows a block diagram of a feedback control of a nanopositioning system 1 as a dynamical control system having a nanopositioner block representing a nanopositioner 2 as a controlled element which provides a setting. The nanopositioner 2 is controlled by a controller block 3 indicating a controller 3. The controller controls the positioning of the nanopositioner 2 in a feedback control scheme which substantially follows a linear time-invariant system given as:

\dot{x}ₖ(t)=Aₖxₖ(t)+Rₖτh(t)

y(t)−Cₖxₖ(t)

wherein u(t) represents the reference signal, A_{K}, B_{K}, C_{K} represent the control parameters of the controller, x_{K}(t) represents a controller state and y(t) represents the output signal of the controller, which corresponds to the input signal of the positioner.

The nanopositioning system 1 receives as a reference input a reference signal r indicating a position or a track the nanopositioner shall navigate. The actual position of the nanopositioner is measured by a (not shown) position detector and a feedback signal f indicating a measurement position value is provided. By means of a difference block 5, a difference signal e is generated which indicates a difference between a reference signal r and the feedback signal f. The difference signal e is provided to the controller.

It is assumed that the nanopositioner represented by the nanopositioner block 2 is fast, i.e. it has a high natural frequency and a damping coefficient, such that a short settling time is achieved relative to the externally provided reference signal r. Furthermore, it is assumed that the reference signal r to be tracked by the nanopositioner is piecewise constant or piecewise affine and of high-bandwidth, wherein its dominant frequency is below the natural frequency of the nanopositioner.

It is presumed that only low-bandwidth disturbances caused by effects such as creep and drift in piezoelectric material applied in the nanopositioner are present in the system.

To improve the tracking performance of the controller, an impulsive state modification block 4 is provided, which changes an internal state of the controller 3 depending on the reference signal r according to the following scheme.

\dot{x}ₖ(t)=Aₖxₖ(t)∥Bₖu(t) when t≈tₜᵣt=1, 2, 3, . . .

xₖ:=qₜxₖ, when t=tₜᵣ t=1, 2, 3, . . .

y(t)=Cₖxₖ(t)

The internal state of the controller corresponds to the variable xₖ(t) of the differential function. The change of the internal state xₖ(t) of the controller is performed at discrete time instants t, wherein the sequence of non-zero real coefficient qᵢ is defined for each time instant t. While the above controller block 3 has a controller state xₖ(t) evolving according to a standard differential equation, the controller state xₖ(t) is modified by the coefficient qᵢ at the discrete time instants when t=tᵢ, i=1, 2, 3 . . . wherein the coefficient qᵢ preferably is dependent on an external signal such as the reference signal, the controller output u(t), the actual position of the nanopositioner, or signals derived from one or more of these signals. According to an embodiment, the controller state xₖ(t) is multiplied by the non-zero real coefficient qᵢ. Other mathematical operations might be usable as well.

According to a first embodiment, where the reference signal r(t) is piecewise constant over time intervals [tᵢ, tᵢ+1], i=0, 1, 2 . . . we assume that there is a sequence of time intervals [tᵢ−1, tᵢ], [tᵢ, tᵢ+1] . . . [tᵢ+n, tᵢ+n+1] where the reference signal r has non-zero values vᵢ−1, vᵢ, . . . vᵢ+n. In the sequence of coefficients qᵢ, qᵢ is the factor by which the piecewise constant signal at the time interval [tᵢ, tᵢ+1] differs from its previous value vᵢ−1 at the time interval [tᵢ−1, tᵢ]:

qᵢ=vᵢ/vᵢ−1.

Since the tracking of r(t) is generally poor when using a low-bandwidth controller 3, the system 1, as shown in FIG. 1 is enhanced by modifying the controller state xₖ(t) at discrete time instants t=tᵢ, i=1, 2, 3 . . . using the coefficient qᵢ. In case the nanopositioner corresponds to an ideal nanopositioner having an infinite natural frequency and an infinitely small settling time, the error of the control system of FIG. 1 tracks a piecewise constant reference signal r with the error:

$$\frac{{q}_{i} {v}_{i}}{δ ( 1 + K ( δ ) )}$$

where K(s) is a Laplace transformation of the transfer function of the controller block 3.

One advantage of the above embodied method for tracking the reference signal r in a feedback loop is that it is also applicable with a controller having a low-bandwidth, i.e. where the controller's crossover frequency is substantially smaller than the frequency of the reference signal tracked. Low bandwidth controllers are desired for their low noise sensitivity.

In FIG. 2 a block diagram illustrating a further embodiment of the present invention relates to a system 10 where the reference signal r(t) is a piecewise affine signal, such as triangular reference signals r for scanning probe applications. In contrast to the embodiment of FIG. 1, a sum block 6 is provided to add a setting signal kFF which is a function of the positioner and the reference signal. In particular the setting signal can be derived from the transfer function P(s) of the positioner and the reference signal r in a setting signal block 7 as explained below.

With this control scheme, it can be shown that the tracking performance directly depends on how the controller is capable of tracking the open-loop tracking error r-P(r), where P (r) denotes the response of the nanopositioner to the reference signal r. For a class of plants under inputs of a piecewise affine reference signal r, the open-loop tracking error is piecewise constant up to residual vibrations caused by discontinuities and non-smoothness in the reference signal r. For example, this applies to the stable plants with transfer function

$$P ( δ ) = \frac{a ( δ )}{b ( δ )} = \frac{{δ}^{m} + {a}_{m - 1} {δ}^{m - 1} + … + {a}_{0}}{{δ}^{n} + {b}_{n - 1} {δ}^{n - 1} + … + {b}_{0}}$$

such that m≦n and kFF=b₀/a₀.

For plants with this type of open-loop tracking error, the above results related to the first embodiment can be applied for tracking piecewise affine signals using an impulse state modification. If the reference signal r(t) is piecewise affine, the intervals [tᵢ, tᵢ+1], i.e. r(t)=sᵢ(t−tᵢ)+ri for tε[tᵢ, tᵢ+1], sᵢ≠0, i=0, 1, 2 . . . , define the sequence qᵢ i=1, 2, 3 . . . as qᵢ=sᵢ/sᵢ−1. In this case, the controller with the impulsive state modification may significantly improve the performance of the system 10. While this embodiment can be suitable for tracking triangular reference signals in scanning probe applications, a further significant improvement can be achieved for triangular reference signals r with changing frequency and amplitudes.

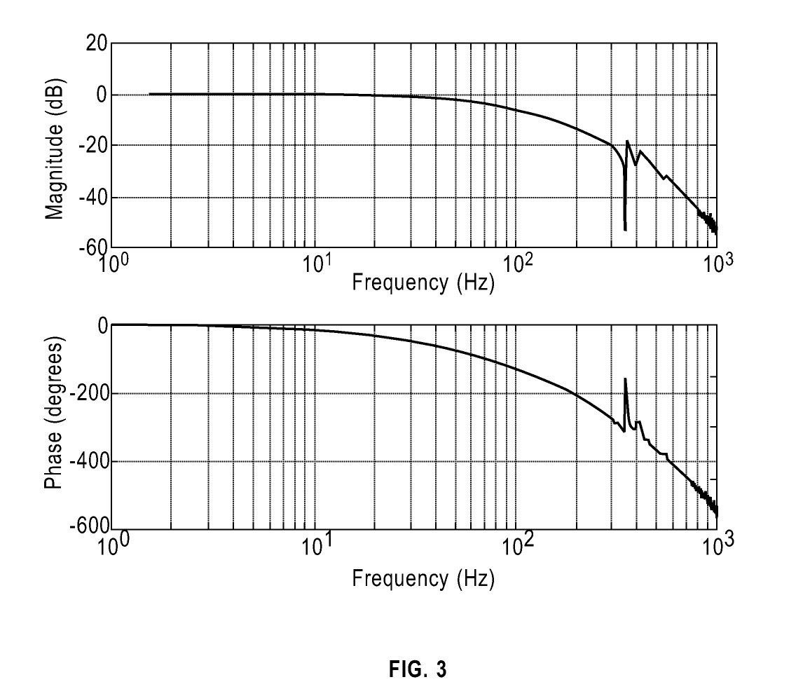

FIG. 3 shows the characteristic of the transfer function of an example of a nanopositioner implemented in the feedback control system with the impulsive state modification as a function of frequency.

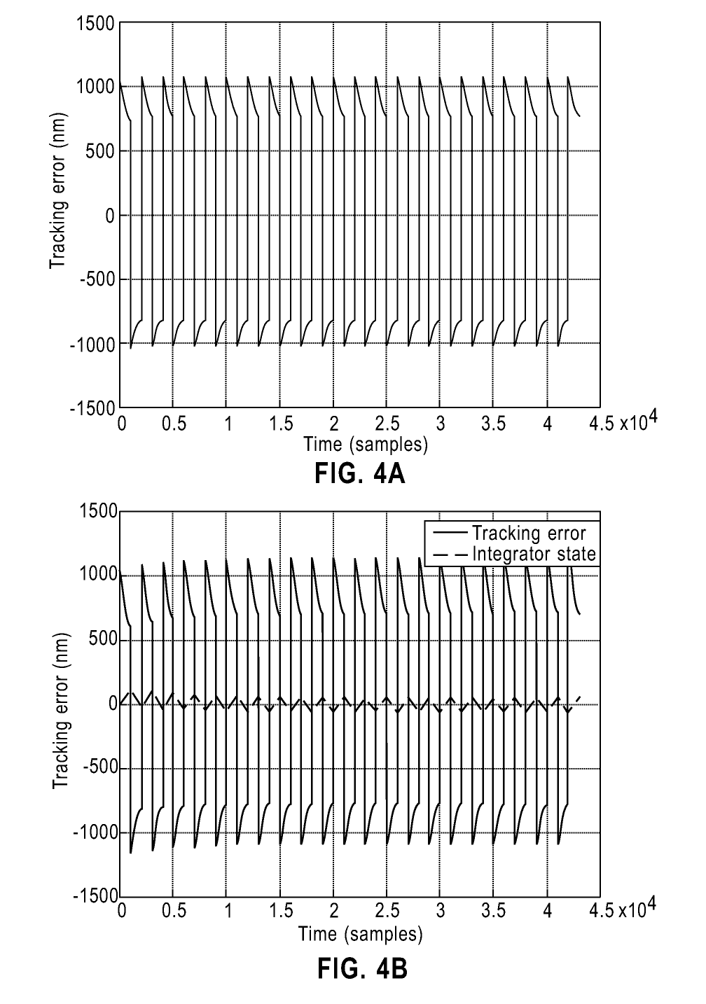

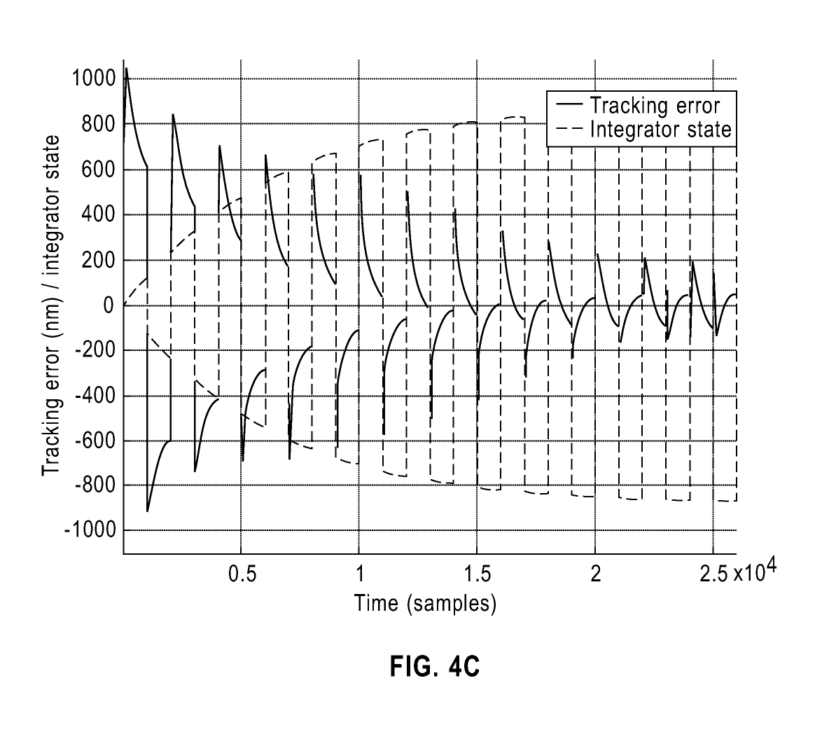

FIGS. 4a to 4c refer to a reference signal r with a triangular waveform of a frequency 6 Hz in the system 10 of FIG. 2. FIG. 4a shows the open loop tracking error of such a system. Furthermore, FIGS. 4b and 4c show the tracking error and the controller state xₖ(t) without the impulsive state modification and with impulsive state modification, respectively. The transfer function of the controller corresponds to 2/s such that its bandwidth is much less than what is needed for tracking a 6 Hz triangular reference signal without the state feedforward.

FIG. 4b shows the tracking error and the controller state when the impulsive state modification was turned off. Because the controller has a low bandwidth, it failed to track the relatively fast triangular reference signal r and the overall performance in terms of tracking error is poor. On the other hand, with the impulsive state modification block online, as shown in FIG. 4c, the tracking error could be reduced down to the residual non-linearity present in the nanopositioner.

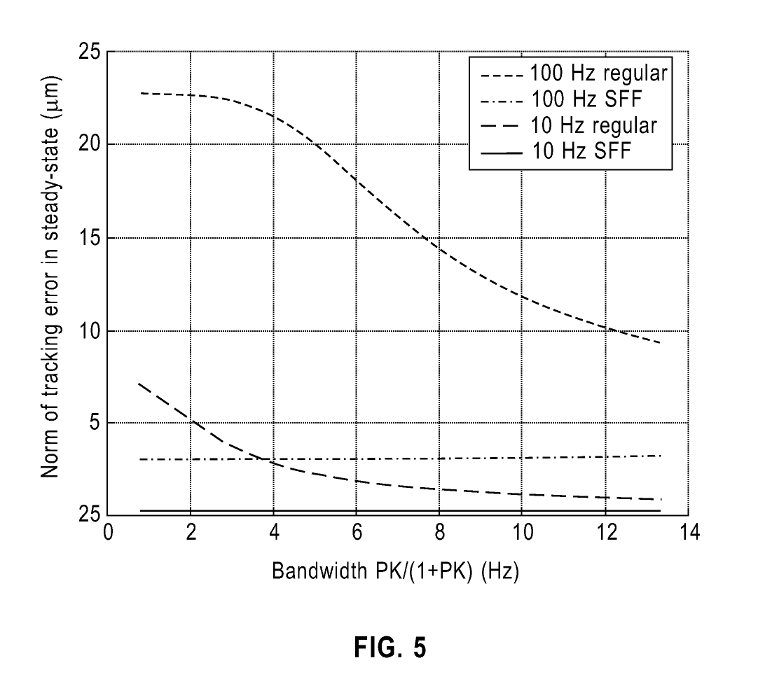

Further simulations show that the performance improvement shown in the experiment might be significant over a broad range of controller gains. In FIG. 5 a nanopositioner having a second-order transfer function is shown having a natural frequency of 1 kHz and a damping ratio of 0.5. The nanopositioner is provided with input reference signals r of 10 Hz and 100 Hz with various gains of the controller wherein the curves are depicted showing the tracking error in cases with and without using the state feed-forward.

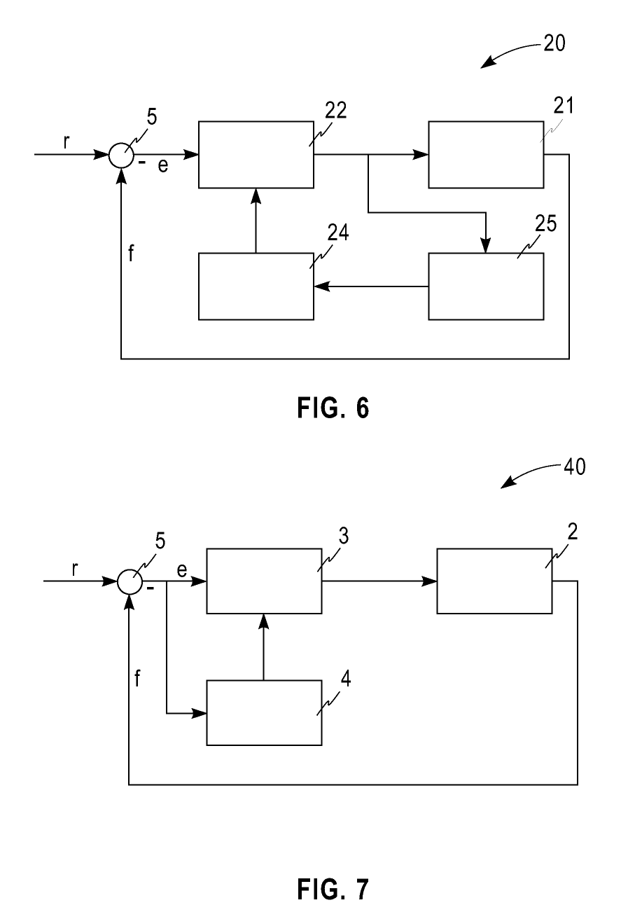

In the block diagram of FIG. 6 another embodiment of the present invention is shown which refers to an impulsive state modification in a feedback setting, wherein the coefficients for modifying the controller states depend on the output measurement of the positioner, i.e. on measured feedback signals. In such a system, sudden disturbances can be suppressed.

The tracking system 20 of FIG. 6 has a nanopositioner block 21 and a controller block 22 which provides a control signal to the nanopositioner block 21. On the input side of the controller block 22 a difference block 5 is provided in order to provide a difference value indicating a difference between the reference signal r(t) and the feedback signal f(t) either as a position measurement signal or as an output of the nanopositioner block 21. An impulsive state modification block 24 is provided which modifies, as mentioned above, the internal state of the controller block 22 depending on an external signal. The function of the impulsive state modification block 24 is application dependent and is not constrained. For instance, the internal state of the controller can be appropriately changed when one or more of the states of the nanopositioner change the value or slope abruptly, i.e. when a sudden change of the gradient of one or more of its states occurs.

In the embodiment shown in FIG. 6, the external signal supplied to the impulsive state modification block 24 is provided by an observer 25 which receives the controller output and the feedback signal, which corresponds to a measurement output of the positioner 21. In the embodiment of FIG. 6, the impulsive changes of the internal state of the controller are driven by an observer signal o. The observer signal o can be provided by the observer 25 which may provide information that is important for the state modification block 24. For instance, the observer 25 can facilitate a full-state feedback or external disturbance estimation.

In many practical scenarios, some of states of the nanopositioner are not accessible directly or without a delay. Such states influence the output of the system (they are observable), but are not (or cannot be) measured. For instance, in a mechanical nanopositioning system this can be a result of a mass on a spring, for example. In a practical setting, it is typically the actual position of the nanopositioner which can be easily measured; however, one does not have a direct access to acceleration or velocity unless tailored sensors (such as an accelerometer) are added. In more complicated systems, such as weather prediction models, some of the states cannot be directly measured at all.

In control of such systems, knowledge of the full state of the nanopositioner can provide valuable information. Under the assumption that the nanopositioner is observable, one can construct an observer, which estimates in real time the actual states which cannot be measured directly. One example of such an observer is the so called Luenberger observer. The observer is constructed based on the model of the nanopositioner and is limited by a trade-off between the speed of convergence and noise. The input to the observer is both the control signal and the system output.

The observer can also be used to estimate external disturbances. Given a model of the nanopositioner and the control signal, external disturbances can be detected based on knowledge of the measured and simulated output. We propose to use impulsive control in a setting where the impulsive change is driven by a feedback signal, possibly provided by the appropriately designed observer.

In FIG. 7 another embodiment of a system 40 is shown. This embodiment differs from the embodiment of FIG. 1 in that the impulsive state modification block 4 is adapted to change the internal state of the controller depending of the difference signal e supplied to the controller block 3 and indicating the tracking error of the feedback loop. For instance the impulsive state modification block 4 can be adapted to modify the internal state of the controller, when an abrupt change in the tracking error is detected.

In contrast to known methods for switching and reset control, embodiments of the invention do not change the control parameters or apply a simple resetting of the controller state. In contrast to the prior art related to the signal transformation approach, embodiments of the invention may provide a better transient performance and an easier implementation. Moreover, embodiments of the invention may support a broader class of reference signals, such as triangular waveforms, having abrupt changes of their values or gradients as well as of their frequency and amplitudes. Furthermore, embodiments of the invention can be well suited for real-time adaptive changes of the impulsive control law.

What is claimed is:

1. A control method for tracking a provided reference signal in a dynamical system, the method comprising:
controlling a controlled element of said dynamical system by means of a control function;
outputting, by said control function, a control signal depending on a reference signal indicating a desired setting of said controlled element and a feedback signal indicating an actual state of said controlled element; and
modifying an internal state of said control function at one or more discrete time instants while applying said control function at time periods not including said discrete time instants, wherein the modification of said internal state depends on a signal external to said control function.

2. The control method according to claim 1, wherein said modifying of the internal state is independent of said control function.

3. The control method according to claim 1, wherein said external signal corresponds to at least one of said reference signal, said feedback signal, said control signal, and a time signal.

4. The control method according to claim 1,
wherein said control function includes a set of at least one differential equation, and
wherein said internal state evolves according to the set of at least one differential equation.

5. The control method according to claim 1,
wherein said reference signal is provided as a piecewise constant signal,
wherein at least one of the said discrete time instants corresponds to a time instant at which the value of said piecewise constant signal changes, and
wherein said internal state is modified at the at least one discrete time instant by multiplying it by a factor.

6. The control method according to claim 5, wherein said factor is obtained as a quotient of a value of said reference signal after the change of said reference signal and a value of said reference signal before the change of said reference signal.

7. The control method according to claim 2,
wherein said reference signal is provided as a piecewise constant signal,
wherein at least one of the said discrete time instants corresponds to a time instant at which the value of said piecewise constant signal changes, and wherein said internal state is modified at the at least one discrete time instant by multiplying it by a factor.

8. The control method according to claim 7, wherein said factor is obtained as a quotient of a value of said reference signal after the change of said reference signal and a value of said reference signal before the change of said reference signal.

9. The control method according to claim 1,
wherein said reference signal is provided as a piecewise affine reference signal,
wherein a discrete time instant corresponds to a time instant where the gradient of said piecewise affine reference signal changes, and
wherein said internal state is modified at the discrete time instant by multiplying it by a factor.

10. The control method according to claim 9, wherein said factor is obtained as a quotient of the gradient of said piecewise affine reference signal after the change and the gradient of said piecewise affine reference signal before the change.

11. The control method according to claim 9,
wherein a setting signal is added to the control signal, and
wherein said setting signal is a function of said controlled element and said reference signal.

12. The control method according to claim 2,
wherein said reference signal is provided as a piecewise affine reference signal,
wherein a discrete time instant corresponds to a time instant where the gradient of said piecewise affine reference signal changes, and
wherein said internal state is modified at the discrete time instant by multiplying it by a factor.

13. The control method according to claim 12, wherein said factor is obtained as a quotient of the gradient of said piecewise affine reference signal after the change and the gradient of said piecewise affine reference signal before the change.

14. The control method according to claim 12,
wherein a setting signal is added to the control signal, and
wherein said setting signal is a function of said controlled element and said reference signal.

15. The control method according to claim 1,
wherein said internal state is modified at a discrete time instant when a change of a state of said controlled element is detected, and
wherein said internal state of said control function is modified depending on the state of said controlled element.

16. The control method according to claim 15,
wherein said internal state of said control function is modified depending on a predicted state of said controlled element, and
wherein said predicted state of said controlled element is derived from said control signal and a detected state of said controlled element.

17. The control method according to claim 2,
wherein said internal state is modified at a discrete time instant when a change of a state of said controlled element is detected, and
wherein said internal state of said control function is modified depending on the state of said controlled element.

18. The control method according to claim 17,
wherein said internal state of said control function is modified depending on a predicted state of said controlled element, and
wherein said predicted state of said controlled element is derived from said control signal and a detected state of said controlled element.

19. A dynamical system for tracking a reference signal, comprising:
a controlled element for being set according to a provided control signal;
a controller for feedback controlling said controlled element by providing said control signal, wherein said controller is adapted to feedback control said controlled element depending on a provided reference signal and a feedback signal indicating an actual state of said controlled element; and
an impulsive state modification block for modifying an internal state of said controller at one or more discrete time instants, while applying said control function at time periods not including said discrete time instants, wherein said impulsive state modification block is adapted to modify said internal state depending on a signal external to said controller.
